(19) United States
(12) Patent Application Publication
(10) Pub. No.: US 2016/0370581 A1
(43) Pub. Date: Dec. 22, 2016

(54) OBJECTIVE FOR VARIABLY ADJUSTING ABERRATIONS

(71) Applicant: Lomographische AG, Wien (AT)

(72) Inventors: Matthias FIEGL-BIBAWY, Vienna (AT); Sally BIBAWY, Vienna (AT)

(21) Appl. No.: 15/165,270

(22) Filed: May 26, 2016

(30) Foreign Application Priority Data
May 28, 2015 (EP) 15169642.4

(51) Int. Cl. G02B 27/00; G02B 9/12; G02B 7/04; G02B 7/02

(52) U.S. Cl. CPC G02B 27/0068; G02B 7/023; G02B 9/12; G02B 7/04

(57) ABSTRACT

An objective for variably adjusting aberrations including:
a first lens group having a first lens of positive refractive power and a second lens of negative refractive power, and
a second lens group having a first lens of negative refractive power and a second lens of positive refractive power, wherein the first lens group is towards the object side and the second lens groups is towards the image side,
wherein there is provided an adjusting device by which the spacing between the first lens group and the second lens group is variably adjustable.

### BACKGROUND OF THE INVENTION

The present invention concerns an objective for variably adjusting aberrations including:
a first lens group having a first lens of positive refractive power and a second lens of negative refractive power, and
a second lens group having a first lens of negative refractive power and a second lens of positive refractive power, wherein the first lens group is towards the object side and the second lens groups is towards the image side.

The aberrations of objectives, that inevitably occur in photography, that is to say imaging errors like for example spherical aberration, astigmatism, coma, image field curvature or distortion are aimed in modern photography to be substantially avoided or corrected by a special selection and arrangement of lens systems in order to obtain an image which is as sharp as possible over the entire image area. In that case a plurality of lens of various kinds of glass are generally combined together and so matched to each other that the joint effect of all imaging errors is minimised. However it is basically not possible to achieve entire avoidance or correction of such imaging errors.

On the other hand, objectives are known in the state of the art, in which the blurring of areas outside the sharp area around the focus are intentionally represented in a different image quality by varying the aberrations. Those variations are of a creative nature, the esthetic quality of such variations commonly being referred to as bokeh. Particularly in portrait photography the background is intentionally kept blurred in order to minimise diversion of the viewer from the main subject. A similar consideration applies to the blurred areas in the foreground of the subject. The representation and the quality impression, linked thereto, of the blurred areas and thus the bokeh is always different in the case of objectives of a different kind. In order in particular in portrait photographs to take account of the factors which are different in each shoot, objectives which are frequently referred to as soft focus objectives have been developed, in which the blur is varied by a variation in the aberration, in particular the spherical aberration.

U.S. Pat. No. 5,841,590 concerns an objective having a first lens group comprising six lenses and a second lens group comprising two lenses. The spacing of the two lenses of the second lens group is variable whereby the spherical aberration is adjustable and as a result it is possible to vary the viewing or the impression of the image by variations in the blur in the background or in the foreground without varying the resolution and the contrast of the subject at the focus. In that respect it is primarily the contrast of the blurred areas that is reduced by the circles of confusion forming the bokeh being less sharply delimited. As a result, the bokeh is variable only to a slight extent. The complicated structure of the objective is a further disadvantage.

### SUMMARY OF THE INVENTION

The object of the present invention therefore is to avoid the foregoing disadvantages, by providing an alternative objective with which it is possible to achieve a more comprehensive variation in the impression of the blurred area with simple means while the sharp area around the focus remains substantially unchanged.

The first lens group arranged at the object side and comprising a first lens of positive refractive power and a second lens of negative refractive power and a second lens group arranged at the image side and comprising a first lens of negative refractive power and a second lens of positive refractive power provide that photographs are produced, which have a sharp area with very good contrast. In that respect, the reference to the object-side and the image-side arrangement is to be interpreted as meaning that that lens group that is towards the object side, being therefore arranged at the object side, is closer to the object in operational use than that lens group that is towards the image side, being therefore arranged at the image side. The lens group arranged at the image side in the assembled condition is therefore towards the film or the image sensor of the camera, where the image is produced and recorded.

By virtue of missing correction lenses, due to the structure involved, there is significant image field curvature, distortion as well as coma and astigmatism. Those aberrations however are advantageous for portraits as they help the viewer to concentrate on the sharply focused area of the image. That applies in particular for that embodiment of the invention in which the first lens group and the second lens group respectively comprise two lenses.

By the provision of an adjusting device by which the spacing of the first lens group from the second lens group is variably adjustable it has surprisingly been found that the bokeh of the photographs recorded with the objective according to the invention is variable in mechanically simple fashion and in that respect comprehensively in an esthetically pleasing manner. In that arrangement the adjusting device can include an adjusting ring which is mounted rotatably on the housing and with which the spacing of the first from the second lens group can be varied. With such a lens arrangement it is possible to variably adjust the coma and the astigmatism in the blurred area while the sharp area of the image is not altered or is only immaterially altered. That concerns in particular a subject which is sharply focused in the center of the image.

In that respect it has further surprisingly been found that, with the objective according to the invention, a ‘swirly bokeh’ is produced, which gives the impression of a swirl directed towards the sharp center whereby the attention of the viewer is attracted even more strongly to the sharp center. With the variation in the spacing between the first lens group and the second lens group, the extent of the bokeh swirl is altered so as to give the impression of a bokeh which is more greatly or less greatly swirled or which rotates to a greater or lesser degree. At the same time the resolution and contrast of an object at the focus and thus the representation of the subject in the sharp area is only immaterially altered.

A variable adjustment of the coma and the astigmatism which in conventional objectives are mostly entirely corrected affords a completely different optional way of varying the impression of the blurred area, wherein those variations are perceived as being esthetic. By the astigmatism not being corrected but only being adjusted to a different value that gives the impression of the more greatly or less greatly swirled bokeh. By the coma not being corrected but being set to a different value the bokeh can be directed towards the sharp center in such a way as to give the impression of an increase in the sharp center (zoom burst effect).

Further advantageous configurations of the invention are defined in the appendant claims.

In an embodiment of the invention the second lens group is fixed in the objective during the variation in the spacing relative to the first lens group while the first lens group is displaced in the objective by the adjusting device along the longitudinal direction of the objective.

In a preferred embodiment of the invention the objective has a second adjusting device with which the focus can be adjusted for focusing, wherein the first lens group and the second lens group are moved by the second adjusting device at the same time and to the same extent relative to the housing of the objective.

In a preferred embodiment the first lens and the second lens of the second lens group are joined to give a doublet lens (doublet) forming a so-called cemented achromatic lens. The first lens and the second lens of the first lens group can in comparison be arranged spaced from each other, wherein in an embodiment the spacing of the first lens and the second lens of the first lens group is invariable.

The first lens of the first lens group has a positive refractive power and is towards the object side in an embodiment. The first lens of the second lens group has a negative refractive power and in an embodiment of the invention is towards the object side. In addition the first lens of the second lens group can be in the form of a meniscus, the second lens of the second lens group can be in the form of a biconvex convergent lens, the first lens of the first lens group can be in the form of a planoconex convergent lens and the second lens of the first lens group can be in the form of a planoconcave divergent lens.

An objective in which the second lens group is a cemented achromatic lens, wherein the lens of negative refractive power is arranged at the object side, and the first lens group is an achromatic lens comprising a planoconvex lens of positive refractive power arranged at the object side and a planoconcave lens of negative refractive power arranged spaced therefrom is also known in the state of the art as a Petzval lens. In this configuration the first lens group also performs the function of an achromatic which jointly with the cemented achromatic lens of the second lens group serves for correction of spherical aberration.

In another embodiment of the invention the first and second lens groups are in the form of a classic Petzval lens, wherein a cemented achromatic lens comprising a biconvex lens and a planoconcave lens of negative refractive power as the first lens group is towards the object side, wherein the lens of positive refractive power is arranged at the object side and a meniscus lens of negative refractive power and spaced therefrom a biconvex lens of positive refractive power is arranged as the second lens group, the meniscus lens being arranged at the object side.

In the variation in the spacing of the first lens group from the second lens group it has further been found that there is always vignetting of the image. The attention of the viewer is additionally drawn to the center of the image by virtue of such shading towards the edge.

In a particularly preferred embodiment of the invention an aperture stop which can be replaceable is arranged between the first lens group and the second lens group.

The bokeh is crucially determined by the appearance of the circles of confusion which occur by virtue of the fact that in blurred areas each spot of the light is imaged in disk form and in that case assumes the form of the aperture. In that case the circle of confusion can be uniformly lit or can be brighter in the proximity of the image edge or at the image center. Further effects which are perceived as being esthetic can be produced in the blurred area by means of replaceable apertures with different opening shapes, for example star-shaped, circular or rectangular.

The spacing of the first lens group from the second lens group can be adjustable stepwise, in which respect it can be provided that the spacing can be varied to an extent of between 10 and 20 mm, preferably between 12 and 16 mm, quite preferably to an extent of 12 mm.

### BRIEF DESCRIPTION OF THE DRAWINGS

Further details and advantages of the present invention are described more fully hereinafter by means of the specific description with reference to the drawings in which:

FIGS. 1a-1g are various views of an objective according to the invention,

FIG. 2 shows a diagrammatic view of a cross-section of the first and second lens group of an objective according to the invention,

FIGS. 3a-3g are diagrammatic views relating to adjustment of the variable spacing of the first lens group from the second lens group,

FIGS. 4a and 4b are perspective diagrammatic views of the first and second lens groups with replaceable aperture arranged therebetween,

FIGS. 5a-5g are photographs taken with a differing spacing of the first lens group from the second lens group,

FIGS. 6a-6g are MTF charts relating to the objective according to the invention with an f-number f/1.9 for various spacings of the first lens group from the second lens group,

FIGS. 7a-7g are MTF charts relating to the objective according to the invention with an f-number f/16 for various spacings of the first lens group from the second lens group, and

FIG. 8 is a perspective sectional view of the objective 1.

### DETAILED DESCRIPTION OF THE INVENTION

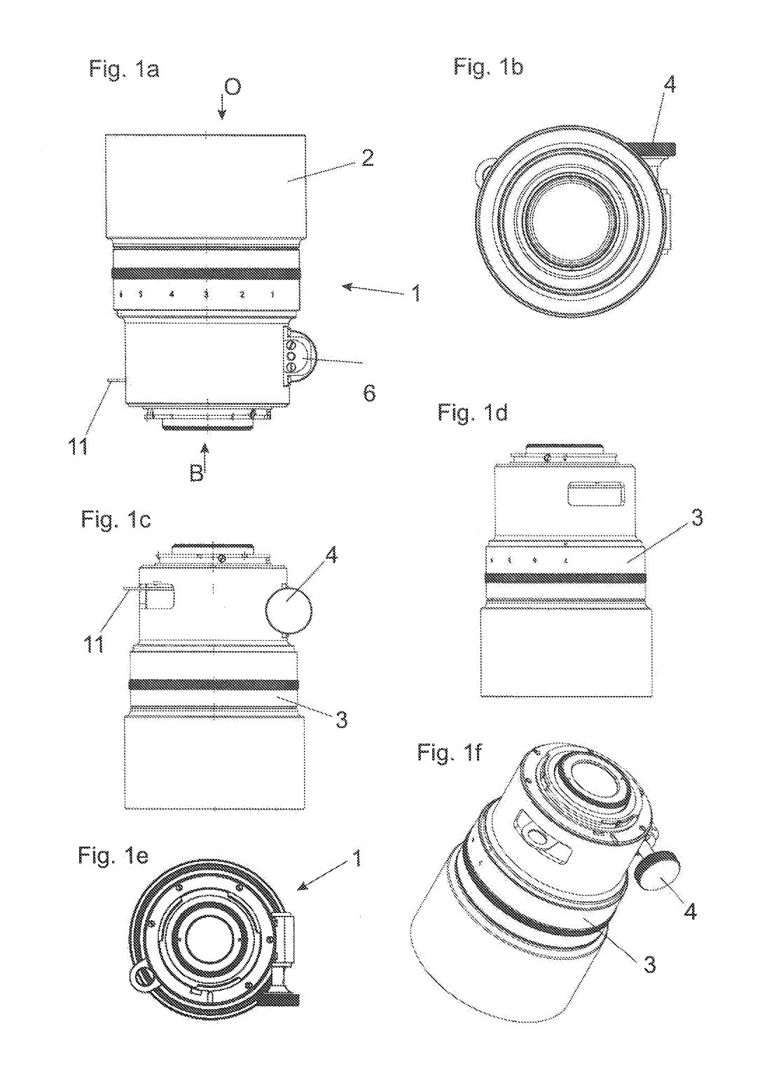

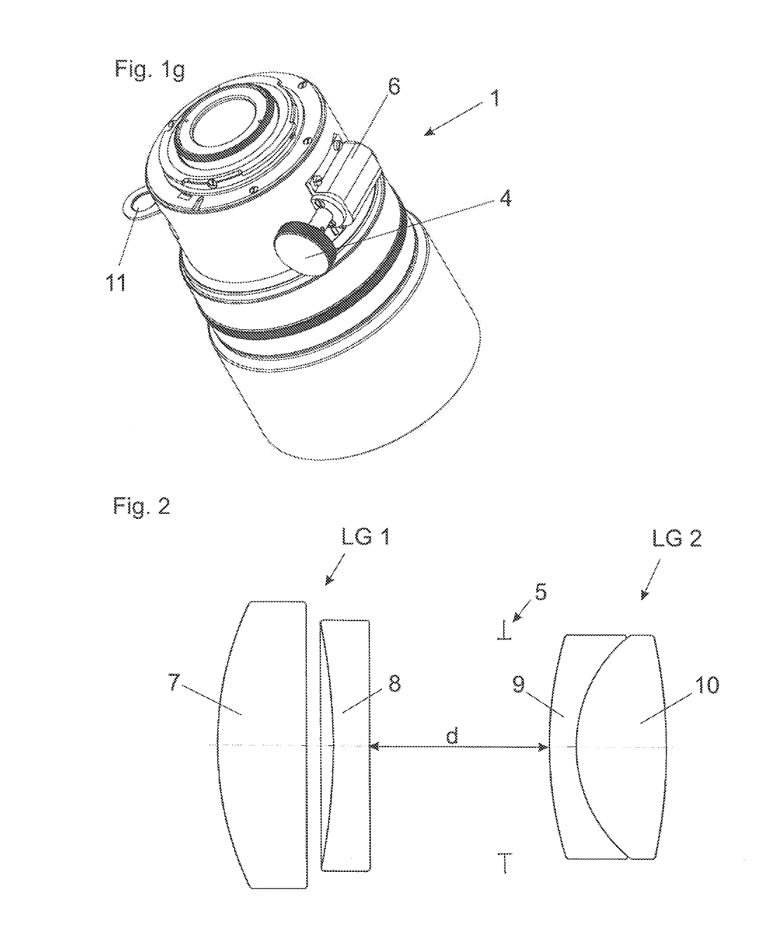

FIGS. 1a through 1e show various views of an objective 1 according to the invention, the first lens group LG1 and the second lens group LG2 being mounted movably in the interior of the housing 2. Here the first lens group LG1 is towards the object side O while the second lens group LG2 is towards the image side B. The objective 1 is connected to a camera with the image side B.

The spacing of the first lens group LG1 relative to the second lens group LG2 is variably adjustable by an adjusting device 15. In this case a rotary ring 3 serves for displacement of the first lens group LG1 in the housing 2 while the second lens group LG2 is fixed.

The first lens group LG1 and the second lens group LG2 are simultaneously moved relative to the housing by a second adjusting device 6 including a setting wheel 4, wherein the spacing of the first lens group LG1 from the second lens group LG2 is kept invariable. That adjustment serves for focusing, the focus of the objective 1 being altered.

Arranged between the first lens group LG1 and the second lens group LG2 is a replaceable aperture stop 5 with which on the one hand the amount of light reaching the image plane is determined and on the other hand the shape of the circles of confusion in the blurred area is determined. A handle 11 serves for pulling out the aperture stop 5.

In the embodiment shown in a diagrammatic cross-sectional view in FIG. 2 the first lens group LG1 towards the object side includes a planoconvex convergent lens 7 towards the object side O, wherein the curved surface is arranged at the object side, and a second lens 8 arranged at a spacing in the form of a planoconvex divergent lens, the curved surface being arranged at the object side. At the image side adjoining the first lens group LG1 are the aperture stop 5 and the second lens group LG2 in the form of a cemented doublet, wherein a first lens 9 of negative refractive power is towards the object side O and is in the form of a meniscus lens while the second lens 10 is towards the image side and is in the form of a biconvex convergent lens.

In an embodiment the lenses are of such a configuration and arrangement that the focal length of the objective is 50 mm. The objective 1 can be used both with analog cameras like for example APS-C cameras or mirror reflex cameras, and also with digital cameras, wherein provided at the image side B are connections with which the objective 1 can be connected to conventional cameras, for example by way of Canon® EF mounts or Nikon® F mounts.

In an embodiment the smallest distance at which a sharp image can be produced is 0.6 m. The minimum circle image is 32 mm. The back focal length is more than 42 mm. The aperture stop 5 is replaceable, in which case it is possible to use for example aperture stops 5 with f-numbers of f/1.9, f/2.8, f/4, f/5.6, f/8, f/11 and f/16, for example so-called Waterhouse aperture stops.

The lenses are coated, as is known in the state of the art, to avoid reflections. For reasons of clarity filters, lens hoods, end caps and the like are no longer shown.

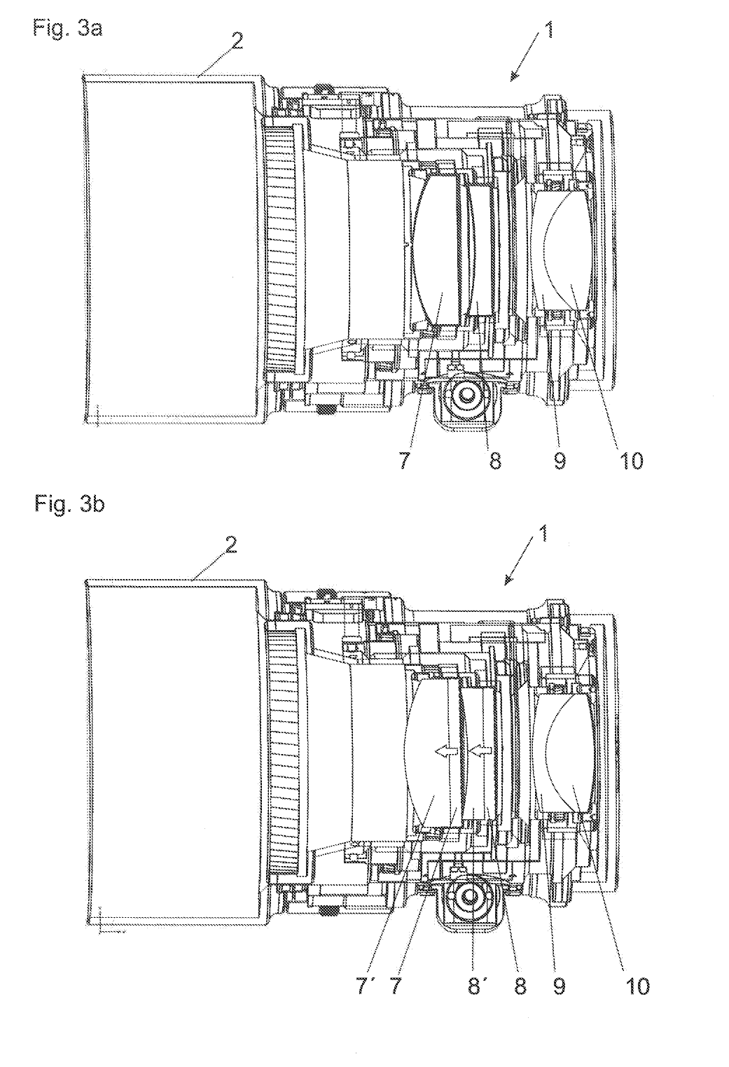

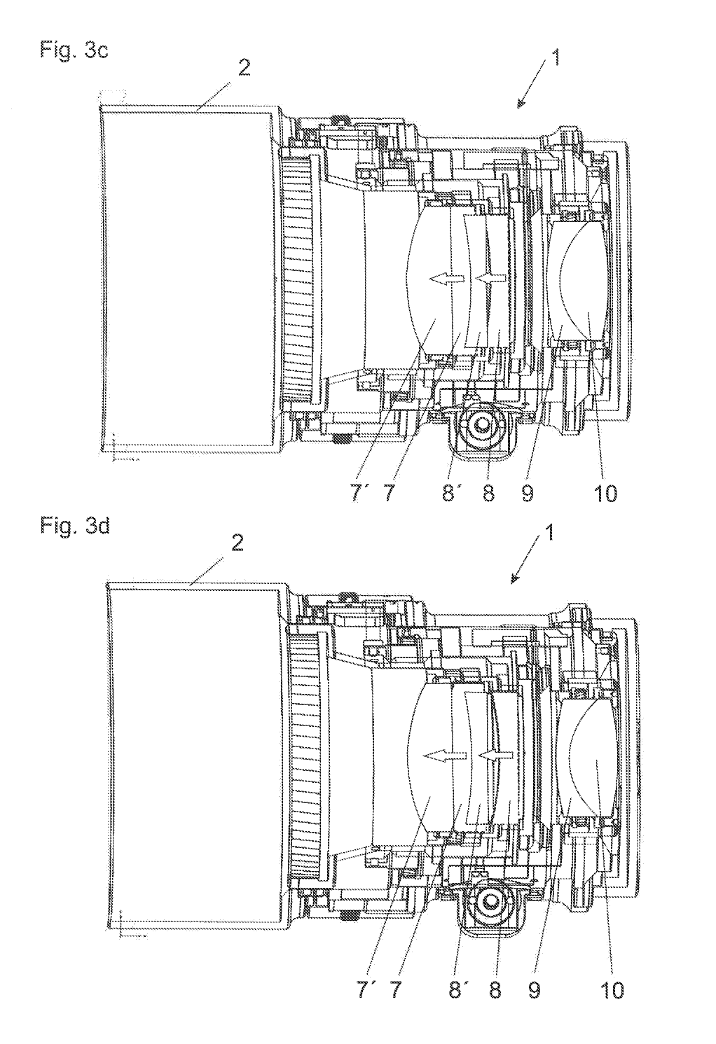

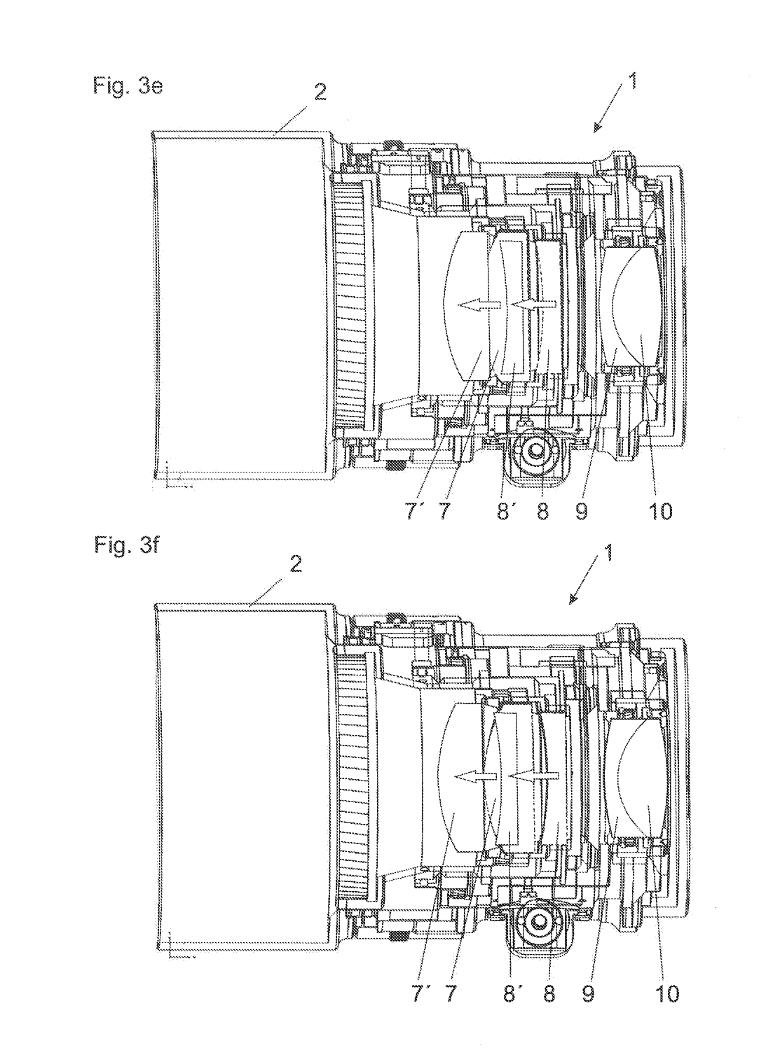

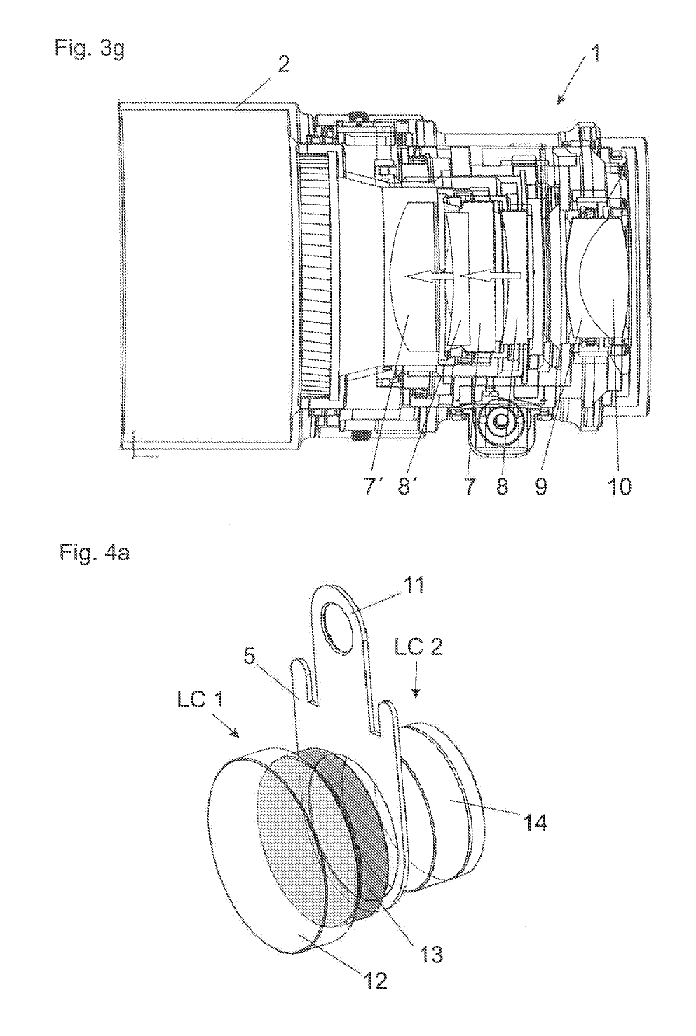

By rotation of the rotary ring 3, in an embodiment of the invention the first lens group LG1 can be displaced in seven steps from the starting spacing d by 2 mm in each case in the direction of the object side O, that is to say in total by 12 mm. That is shown in the diagrammatic views in FIGS. 3a through 3g. In that case the direction of displacement of the lenses 7, 8 is shown by arrows in FIGS. 3b through 3g along the longitudinal direction of the objective 1, wherein the original position of the lenses 7, 8 is identified by the lenses 7, 8 shown in broken lines. During the displacement of the first lens group LG1 the second lens group LG2 remains fixed in the objective. While the image of the subject at the focus of the objective 1 is not varied or is only immaterially varied and still remains sharp, due to the variation in the spacing d of the first lens group LG1 from the second lens group LG2, the blurred area in the foreground and in the background of the subject experiences a variation due to the variation in spacing, wherein the swirly bokeh afforded with the lens arrangement according to the invention, upon a displacement of the first lens group LG1 from a smaller spacing relative to the second lens group LG2 to a larger spacing relative to the second lens group LG2, by virtue of the variations in coma and astigmatism, give an impression which is rotating more and more strongly and which is enhanced at the greatest spacing to afford a tunnel-like impression, whereby the attention of the viewer is inevitably drawn to the sharp area and the subject there. During the variation in spacing the bokeh involves an impression which rotates to an ever increasing extent. During the entire adjustment optical vignetting occurs. A subject arranged at the image center is also emphasised by that shading towards the image edge.

In an embodiment of the invention the following values arise for the different spacings of the first lens group LG1 from the second lens group LG2:

| | | | | Maximum |
|---|---|---|---|---|
| | Image | Focal | Back | focal length |
| Spacing | angle | length | focal length | regulation |
| d | 43.5° | 56.8 mm | 39.72 mm | 116.41 μm |
| d + 2 mm | 43.0° | 57.3 mm | 39.53 mm | 111.93 μm |
| d + 4 mm | 42.4° | 57.9 mm | 39.35 mm | 107.50 μm |
| d + 6 mm | 41.9° | 58.4 mm | 39.16 mm | 103.03 μm |
| d + 8 mm | 41.4° | 59.0 mm | 38.96 mm | 98.75 μm |
| d + 10 mm | 40.9° | 59.6 mm | 38.76 mm | 94.37 μm |
| d + 12 mm | 40.4° | 60.2° | 38.56 mm | 90.20 μm |

It can be seen from those values that focal length and back focal length and thus the sharp area of the image change only slightly during the variation in the spacing of the first lens group LG1 from the second lens group LG2. The image angle becomes somewhat less in that case.

Images 5a through 5g show photographs for each of the seven stages of the spacing d, variable stepwise, of the first lens group LG1 from the second lens group LG2. The more greatly rotating impression of the bokeh can be clearly seen.

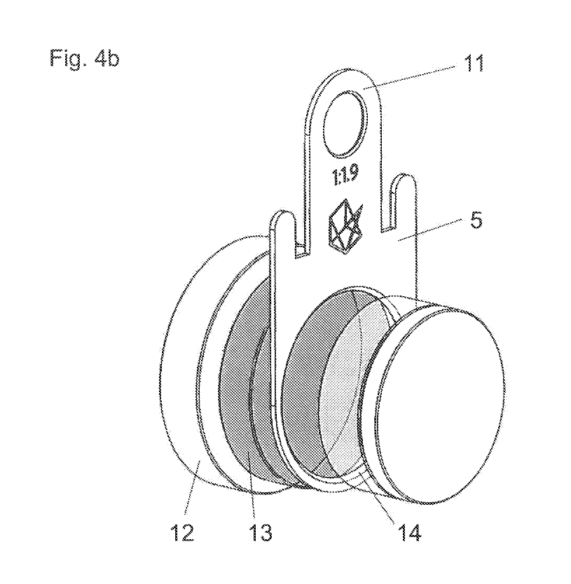

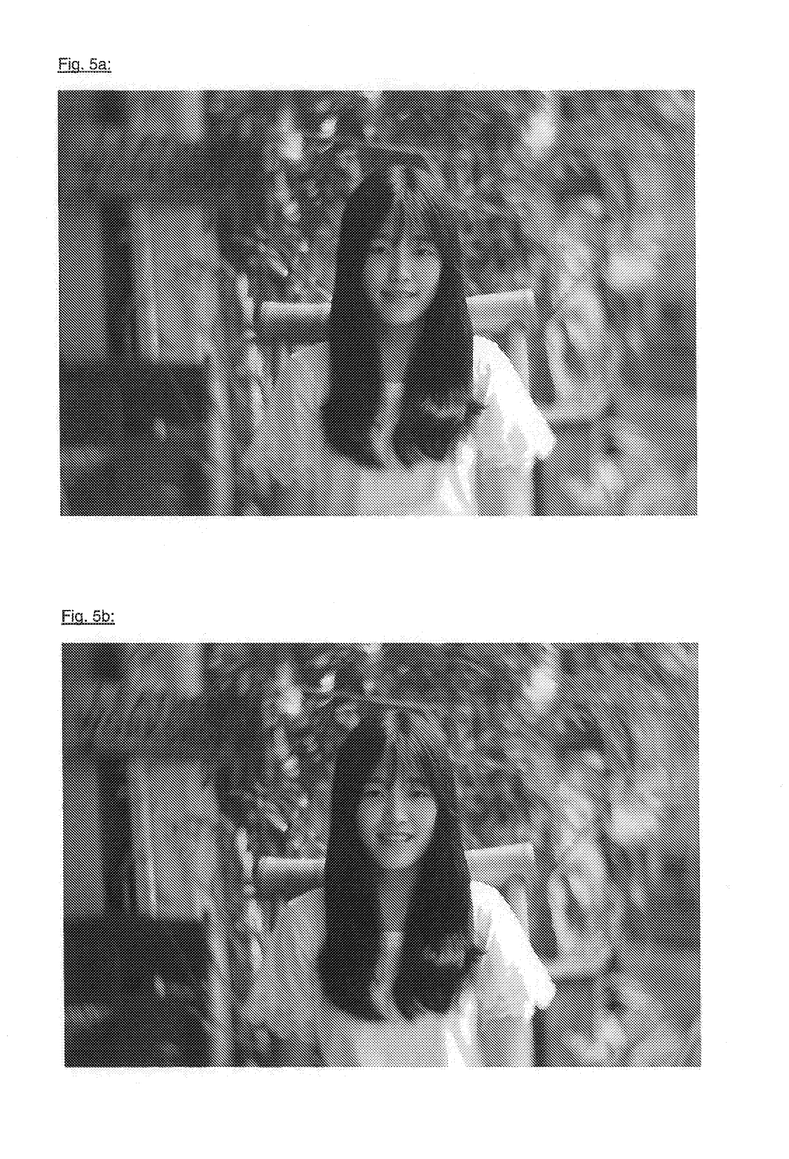

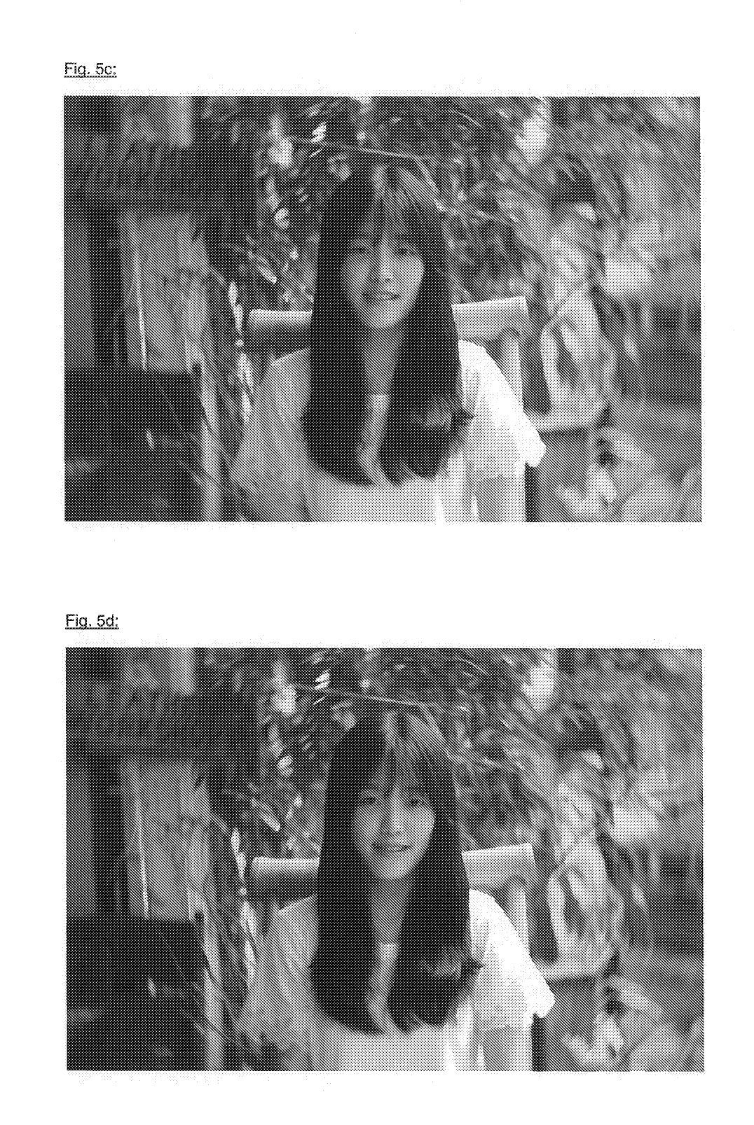

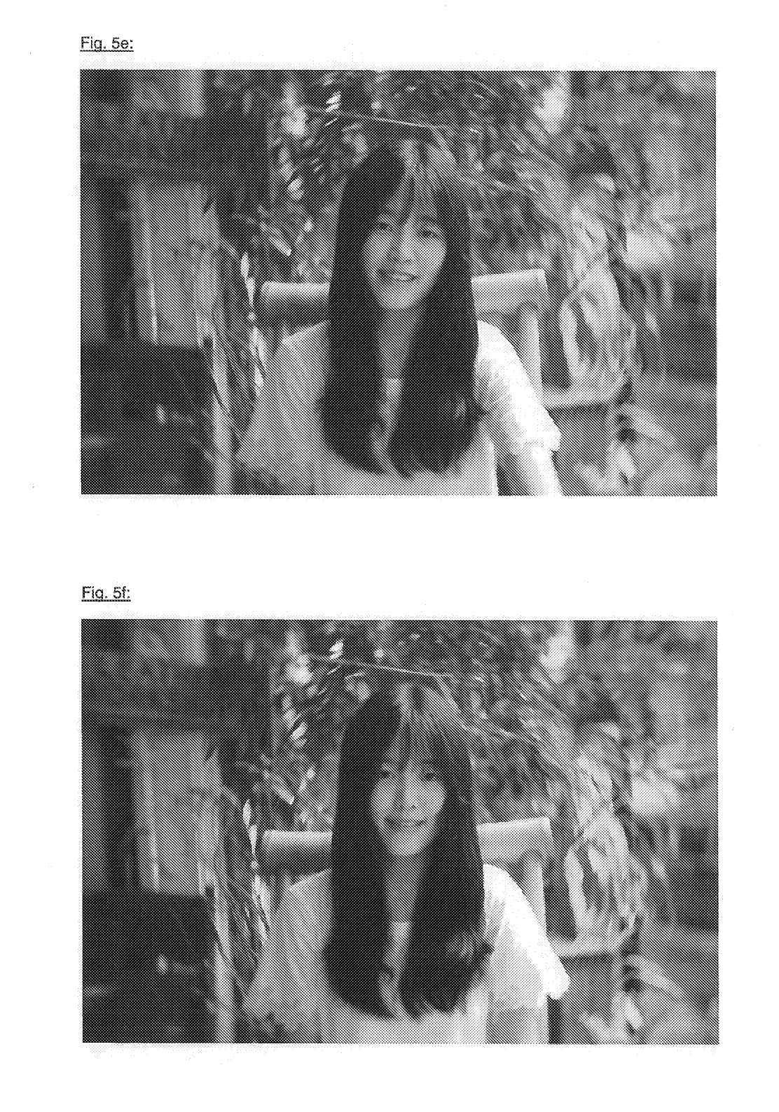

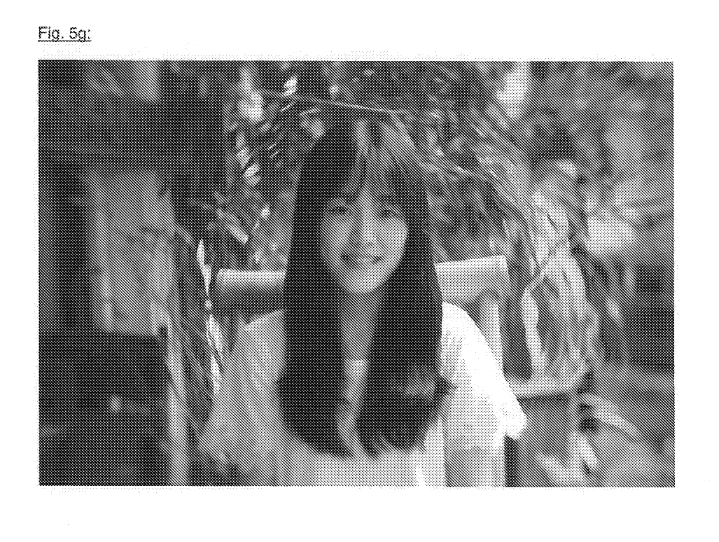

FIGS. 4a and 4b show diagrammatic perspective views of the first lens group LG1, illustrating the holders 12 and 13 of the first lens 7 and the second lens 8 of the first lens group LG1.

As the first lens 9 and the second lens 10 of the second lens group LG2 are cemented to give an achromatic lens the second lens group LG2 requires only one holder 14. The aperture stop 5 with handle 11 for replacement is arranged between the holders 12, 13 and 14.

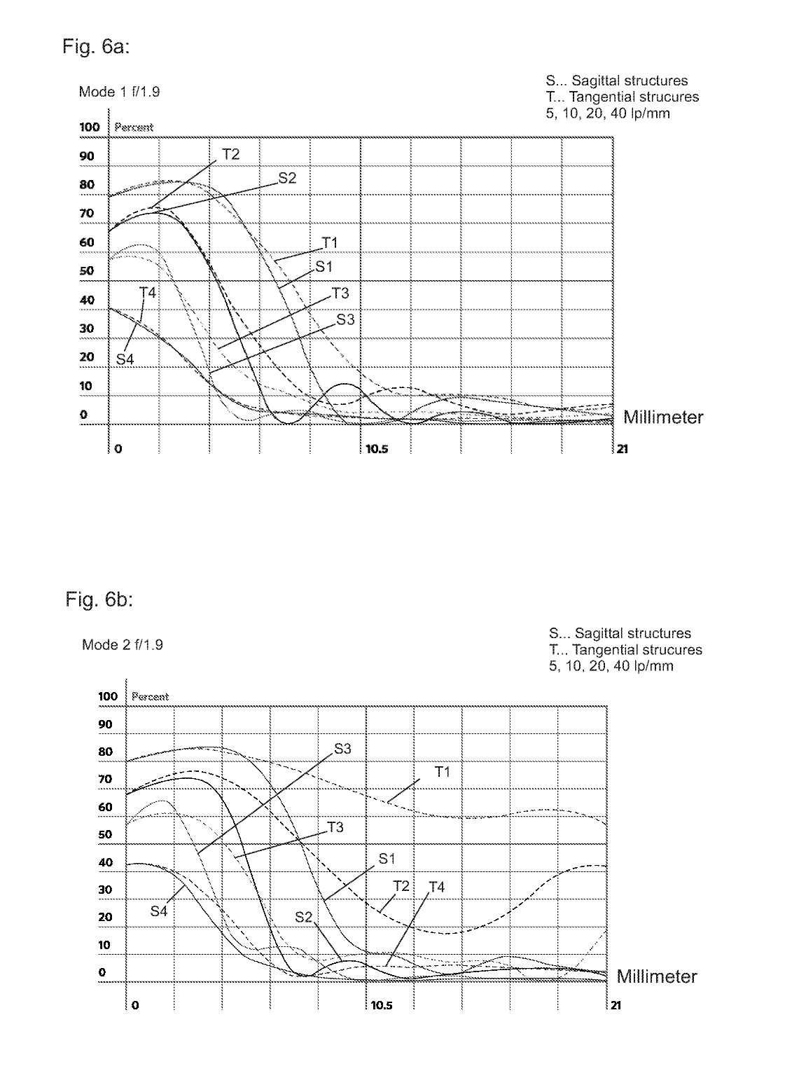

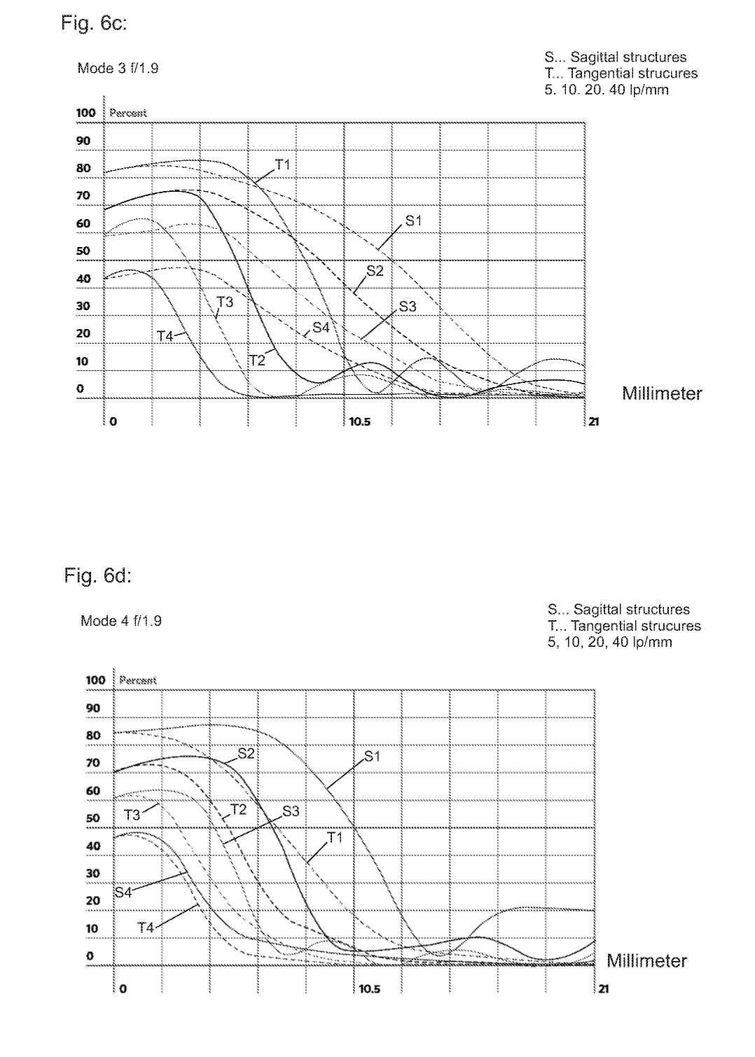

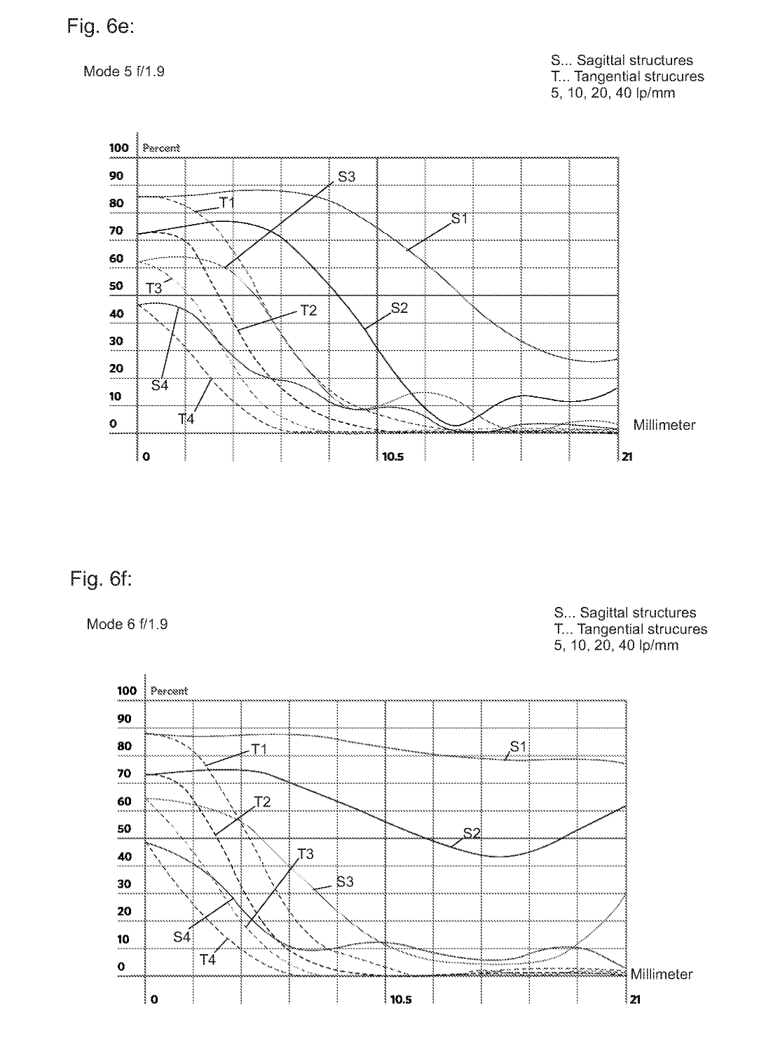

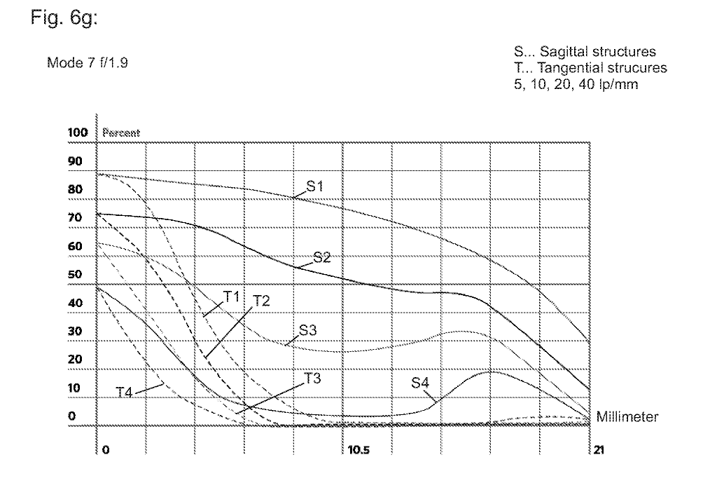

FIGS. 6a through 6g show MTF charts for an objective 1 according to the invention with an aperture stop 5 with f-number f/1.9 in which the spacing d of the first lens group LG1 relative to the second lens group LG2 is increased in each case by 2 mm. In this respect the MTF charts are given in each case for the full opening and for large recording distances (focus to infinite). The contrast in percent is plotted on the ordinate while the distance from the image center is plotted in millimeters on the abscissa. In the present case the image sensor is 24 mm×36 mm so that the diagonal is around 42 mm in length. In each chart four solid curves S1, S2, S3 and S4 are plotted for sagittal structures and for broken-line curves T2, T2, T3 and T4 are plotted for tangential structures with white light. In this case the contrast in respect of the curves S1, S2 is for a resolution 5 lp/mm, in respect of the curves S2, T2 for 10 lp/mm, in respect of the curves S3, T3 for 20 lp/mm and in respect of the curves S4, T4 for 40 lp/mm. For that reason the curves S1, T1 and S2, T2 give an impression about the contrast characteristics for coarser object structures while the curves S3, T3 and S4, T4 document the resolution capability of fine and very fine object structures.

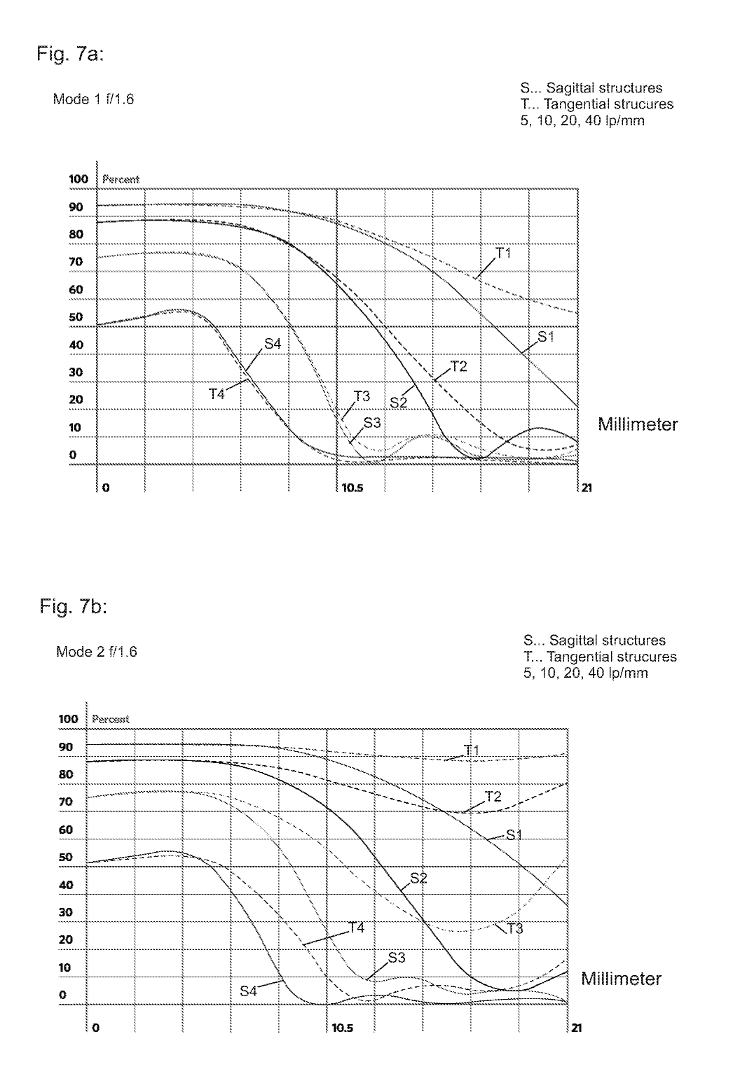

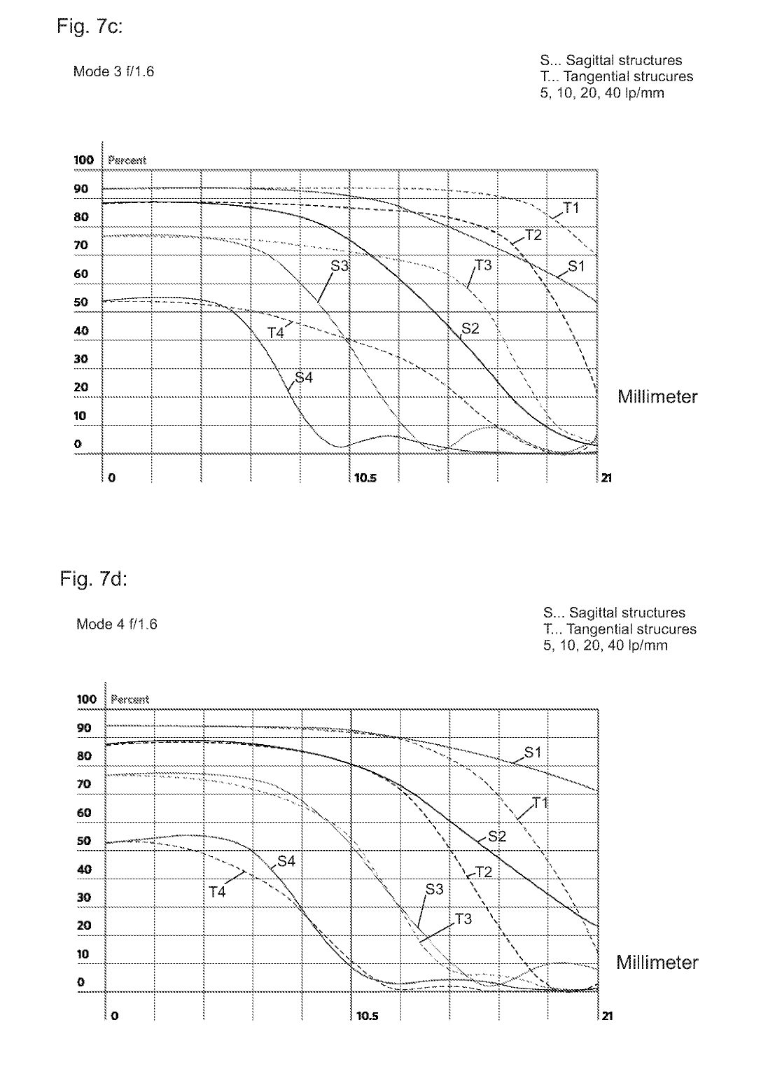

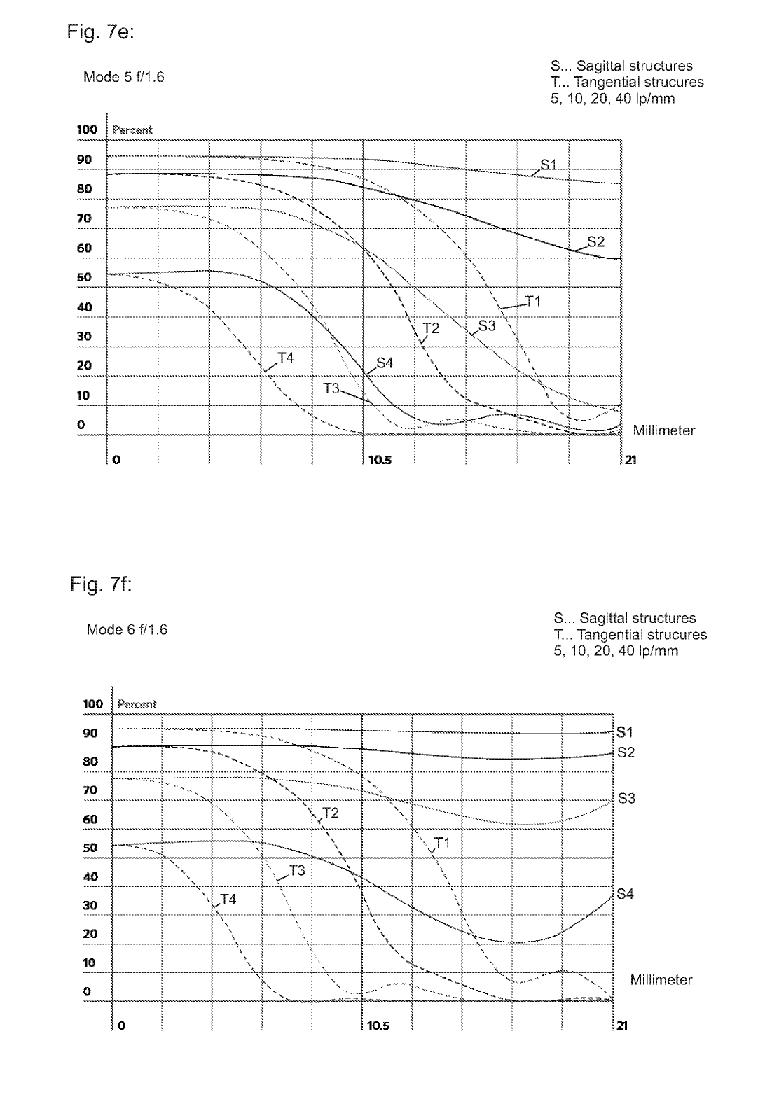

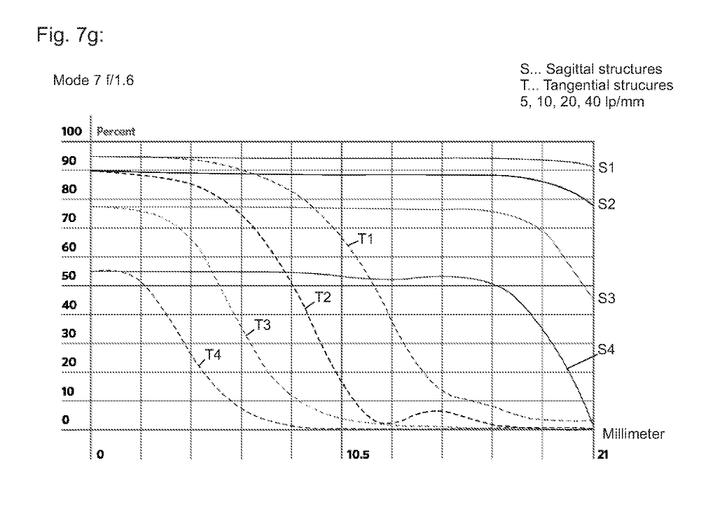

FIGS. 7a through 7g correspond to FIGS. 6a through 6b but with an f-number f/16.

FIGS. 6a and 7a give the smallest spacing between the first lens group LG1 and the second lens group LG2. In subsequent FIGS. 6a, 7b, that spacing increases by two mm in each case until at FIGS. 6g, 7g the spacing has increased by a total of 12 mm.

It can be seen from the MTF charts that the sagittal and tangential curves belonging to the same resolution are at spacings from each other which basically characterise the optical impression and aberrations, wherein with a differing spacing in respect of the first lens group LG1 from the second lens group LG2 there is also a different bokeh, which can be seen from the differing curves S1, T1, S2, T2, S3, T3, S4, T4 in individual FIGS. 6 and 7.

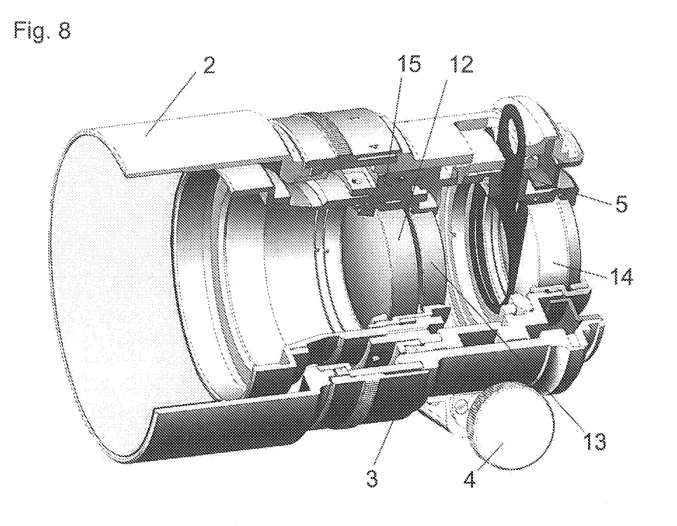

FIG. 8 shows a perspective sectional view of an objective 1 according to the invention, in which it can be seen that the adjusting device 15 has mechanical holding devices with which the holders 12 and 13 for the first lens 7 and the second lens 8 of the first lens group LG1 can be displaced along the longitudinal axis of the objective 1. In this case displacement is effected by way of a rotary ring 3 mounted rotatably to the housing. During the variation in the spacing d between the first lens group LG1 and the second lens group LG2 the second lens group LG2 is fixed in the housing 2. For focusing by way of the setting wheel 4 the holders 12, 13 and the holder 14 for the first lens 9 and the second lens 10 of the second lens group LG2 are displaced in parallel relationship, with the aperture stop 5 also being displaced.

1. An objective for variably adjusting aberrations including:
a first lens group having a first lens of positive refractive power and a second lens of negative refractive power, and
a second lens group having a first lens of negative refractive power and a second lens of positive refractive power, wherein the first lens group is towards the object side and the second lens groups is towards the image side,
wherein there is provided an adjusting device by which the spacing between the first lens group and the second lens group is variably adjustable.

2. An objective as set forth in claim 1 wherein for varying the spacing the second lens group is fixed in the objective and the first lens group is mounted displaceably in the objective.

3. An objective as set forth in claim 1 wherein the first lens group comprises two lenses and/or the second lens group comprises two lenses.

4. An objective as set forth in claim 1 wherein the first lens and the second lens of the second lens group are cemented to give a doublet lens.

5. An objective as set forth in claim 1 wherein the first lens and the second lens of the first lens group are arranged spaced from each other.

6. An objective as set forth in claim 5 wherein the spacing of the first lens from the second lens is invariable.

7. An objective as set forth in claim 1 wherein the first lens of the first lens group is towards the object side.

8. An objective as set forth in claim 1 wherein the first lens of the second lens group is towards the object side.

9. An objective as set forth in claim 1 wherein the first lens of the second lens group is a meniscus of negative refractive power and/or the first lens of the first lens group is a planoconvex lens of positive refractive power.

10. An objective as set forth in claim 1 wherein the second lens of the second lens group is a biconvex lens of positive refractive power and/or the second lens of the first lens group is a planoconcave lens of negative refractive power.

11. An objective as set forth in claim 1 wherein a preferably interchangeable aperture is arranged between the first lens group and the second lens group.

12. An objective as set forth in claim 1 wherein the adjusting device includes an adjusting ring mounted rotatably on the housing.

13. An objective as set forth in claim 1 wherein the spacing of the first lens group from the second lens group is variable stepwise.

14. An objective as set forth in claim 1 wherein the spacing of the first lens group from the second lens group is variable in an extent of between 6 and 20 mm, preferably between 10 and 16 mm, quite preferably in an extent of 12 mm.

15. An objective as set forth in claim 1 wherein there is provided a second adjusting device (6) by which the first lens group (LG1) and the second lens group (LG2) are displaceable jointly relative to the housing (2) of the objective (1) for focusing.
